(19) United States
(12) Patent Application Publication
(10) Pub. No.: US 2003/0236998 A1
(43) Pub. Date: Dec. 25, 2003

(54) Method and system for configuring a computer system using field replaceable unit identification information

(75) Inventors: Raymond J. Gilstrap, Milpitas, CA (US); Emrys Williams, Eversholt (GB); Robert Abramovitz, Belmont, CA (US)

Correspondence Address: Lawrence J. Merkel, Meyertons, Hood, Kivlin, Kowert & Goetzel, P.C., P.O. Box 398, Austin, TX, 78767, US

(73) Assignee: Sun Microsystems, Inc., Santa Clara, CA (US)

(21) Appl. No.: 10/413,117

(22) Filed: Apr. 14, 2003

Related U.S. Application Data
(60) Provisional application No. 60/381,355, filed on May 17, 2002.
(60) Provisional application No. 60/381,116, filed on May 17, 2002.
(60) Provisional application No. 60/381,400, filed on May 17, 2002.

(51) Int. Cl. G06F 11/30

(52) U.S. Cl. 713/200

(57) ABSTRACT

A method includes providing at least one field replaceable unit in a computer system. The field replaceable unit has a memory device configured to store field replaceable unit data. An authentication check is performed on the field replaceable unit data. The field replaceable unit is identified as being unqualified responsive to a failure of the authentication check. A computer system includes at least one field replaceable unit and a system controller. The field replaceable unit has a memory device configured to store field replaceable unit data. The system controller is configured to perform an authentication check on the field replaceable unit data, and identify the field replaceable unit as being unqualified responsive to a failure of the authentication check.

This patent application claims benefit of priority to U.S. Provisional Patent Application Serial No. 60/381,355, filed on May 17, 2002. This patent application claims benefit of priority to U.S. Provisional Patent Application Serial No. 60/381,116, filed on May 17, 2002. This patent application claims benefit of priority to U.S. Provisional Patent Application Serial No. 60/381,400, filed on May 17, 2002. The above applications are incorporated herein by reference in their entireties.

### BACKGROUND OF THE INVENTION

1. Field of the Invention

This invention relates generally to a processor-based computer system and, more particularly, to a method and system for configuring a computer system using field replaceable unit identification information.

2. Description of the Related Art

The last several years have witnessed an increased demand for network computing, partly due to the emergence of the Internet. Some of the notable trends in the industry include a boom in the growth of Applications Service Providers (ASPs) that provide applications to businesses over networks and enterprises that use the Internet to distribute product data to customers, take orders, and enhance communications with employees.

Businesses typically rely on network computing to maintain a competitive advantage over other businesses. As such, developers, when designing processor-based systems for use in network-centric environments, may take several factors into consideration to meet the expectation of the customers, factors such as the functionality, reliability, scalability, and performance of such systems.

One example of a processor-based system used in a network-centric environment is a mid-frame server system. Typically, mid-frame servers are employed in high bandwidth systems requiring high availability factors. Minimizing system downtime is an important system management goal, as downtime generally equates to significant lost revenue. Typically, such computer systems are provided with replaceable components or modules that may be removed and/or installed without shutting down the system. This on-line replacement capability is commonly referred to as a hot-pluggable or hot-swappable environment.

Unlike current desktop computer systems, in which the internal cards and devices are essentially disposable (i.e., they are replaced if they fail, and the defective part is discarded without repair), the individual components used to construct higher-end systems, such as the mid-frame server described above, are typically returned to the manufacturer or a third-party vendor associated with the manufacturer for repair. Repaired units are then reinstalled in the same or in a different mid-frame server. Such repairable components are commonly referred to as field replaceable units (FRUs). In the service life of a particular FRU, it may be installed in multiple servers owned by different customers. Exemplary units that may be field replaceable are system control boards, processing boards, memory modules installed on one of the processing boards, input/output (I/O) boards, power supplies, cooling fans, and the like.

To achieve the high availability expectations for server systems, components are typically subjected to a number of qualification tests to ensure their robustness and integrity. Hence, only components that are qualified are permitted to be installed. There exists a wide variety of grades for commercially available components. By insisting on the use of qualified parts, system suppliers attempt to reduce this grade variation to increase the reliability of the server. Nonetheless, due to the sometimes costly nature of server components, there exists an incentive to employ unqualified, less expensive replacement components. There also exists the possibility that counterfeit components may be produced and passed off as qualified parts. The use of such unqualified or counterfeit components may potentially degrade the performance of the system and its reliability.

### SUMMARY OF THE INVENTION

One aspect of the present invention is seen in a method including providing at least one field replaceable unit in a computer system. The field replaceable unit has a memory device configured to store field replaceable unit data. An authentication check is performed on the field replaceable unit data. The field replaceable unit is identified as being unqualified responsive to a failure of the authentication check.

Another aspect of the present invention is seen in a computer system including at least one field replaceable unit and a system controller. The field replaceable unit has a memory device configured to store field replaceable unit data. The system controller is configured to perform an authentication check on the field replaceable unit data, and identify the field replaceable unit as being unqualified responsive to a failure of the authentication check.

### BRIEF DESCRIPTION OF THE DRAWINGS

The invention may be understood by reference to the following description taken in conjunction with the accompanying drawings, in which like reference numerals identify like elements, and in which:

FIG. 1 is a simplified block diagram of a system in accordance with one embodiment of the present invention;

FIG. 2 is a diagram of a field replaceable unit identification (FRUID) memory;

FIG. 3 is a simplified block diagram illustrating a field replaceable unit (FRU) having a plurality of submodules; and

FIG. 4 is a simplified flow diagram of a method for configuring a computer system in accordance with another embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, and/or magnetic signals capable of being stored, transferred, combined, compared, and otherwise manipulated. It has proven convenient at times, principally for reasons of common usage, to refer to these signals as bits, values, elements, symbols, characters, terms, numbers, and the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” and the like, refer to the action and processes of a computer system, or similar electronic computing device, that manipulates and transforms data represented as physical, electronic quantities within the computer system's registers and/or memories into other data similarly represented as physical quantities within the computer system memories and/or registers and/or other such information storage, transmission and/or display devices.

The programming instructions necessary to implement these software functions may be resident on various storage devices. Such storage devices referred to in this discussion may include one or more machine-readable storage media for storing data and/or instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, and/or modules in the various systems may be stored in respective storage devices. The instructions, when executed by a respective control unit, cause the corresponding system to perform programmed acts as described.

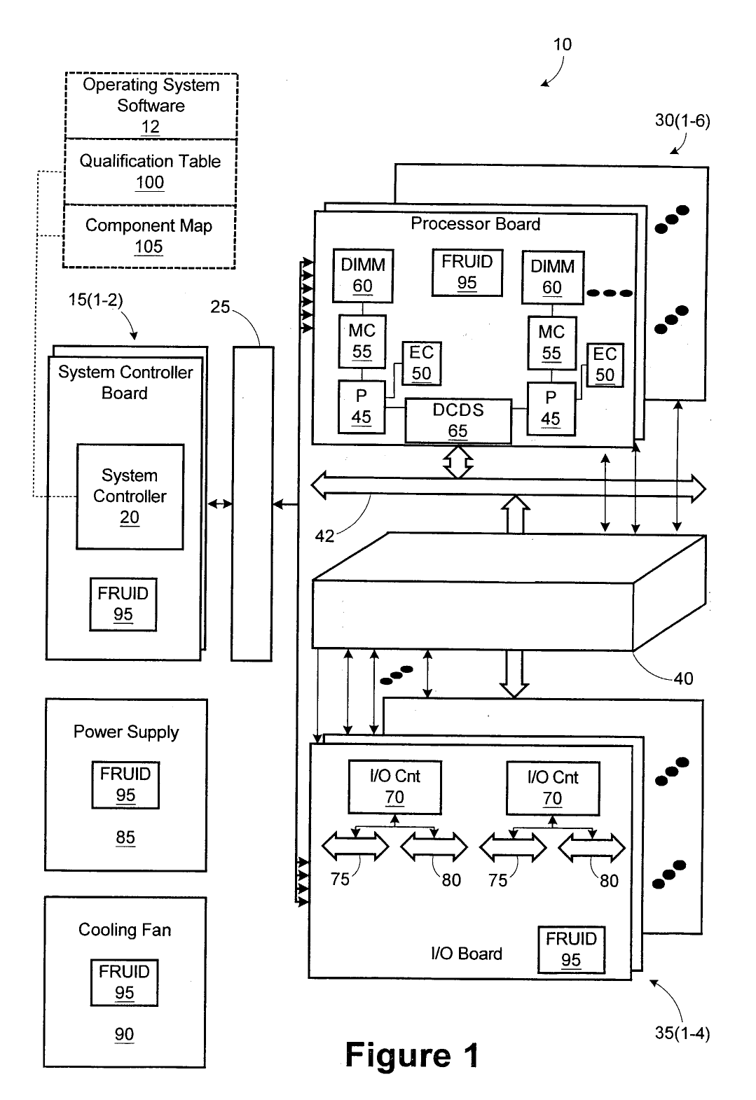

Referring now to FIG. 1, a block diagram of a system 10 in accordance with one embodiment of the present invention is illustrated. In the illustrated embodiment, the system 10 is adapted to run under an operating system 12, such as the Solaris™ operating system offered by Sun Microsystems, Inc. of Palo Alto, Calif.

The system 10, in one embodiment, includes a plurality of system control boards 15(1-2), each including a system controller 20, coupled to a console bus interconnect 25. The system controller 20 may include its own microprocessor and memory resources. The system 10 also includes a plurality of processing boards 30(1-6) and input/output (I/O) boards 35(1-4). The processing boards 30(1-6) and I/O boards 35(1-4) are coupled to a data interconnect 40 and a shared address bus 42. The processing boards 30(1-6) and I/O boards 35(1-4) also interface with the console bus interconnect 25 to allow the system controller 20 access to the processing boards 30(1-6) and I/O boards 35(1-4) without having to rely on the integrity of the primary data interconnect 40 and the shared address bus 42. This alternative connection allows the system controller 20 to operate even when there is a fault preventing main operations from continuing.

In the illustrated embodiment, the system 10 is capable of supporting 6 processing boards 30(1-6) and 4 I/O boards 35(1-4). However, the invention is not limited to such an exemplary implementation, as any number of such resources may be provided. Also, the invention is not limited to the particular architecture of the system 10.

For illustrative purposes, lines are utilized to show various system interconnections, although it should be appreciated that, in other embodiments, the boards 15(1-2), 30(1-6), 35(1-4) may be coupled in any of a variety of ways, including by edge connectors, cables, and/or other available interfaces.

In the illustrated embodiment, the system 10 includes two control boards 15(1-2), one for managing the overall operation of the system 10 and the other for providing redundancy and automatic failover in the event that the other board 15(1-2) fails. Although not so limited, in the illustrated embodiment, the first system control board 15(1) serves as a “main” system control board, while the second system control board 15(2) serves as an alternate hot-swap replaceable system control board.

The main system control board 15(1) is generally responsible for providing system controller resources for the system 10. If failures of the hardware and/or software occur on the main system control board 15(1) or failures on any hardware control path from the main system control board 15(1) to other system devices occur, system controller failover software automatically triggers a failover to the alternative control board 15(2). The alternative system control board 15(2) assumes the role of the main system control board 15(1) and takes over the main system controller responsibilities. To accomplish the transition from the main system control board 15(1) to the alternative system control board 15(2), it may be desirable to replicate the system controller data, configuration, and/or log files on both of the system control boards 15(1-2). During any given moment, generally one of the two system control boards 15(1-2) actively controls the overall operations of the system 10. Accordingly, the term “active system control board,” as utilized hereinafter, may refer to either one of the system control boards 15(1-2), depending on the board that is managing the operations of the system 10 at that moment.

For ease of illustration, the data interconnect 40 is illustrated as a simple bus-like interconnect. However, in an actual implementation the data interconnect 40 is a point-to-point switched interconnect with two levels of repeaters or switches. The first level of repeaters is on the various boards 30(1-6) and 35(1-4), and the second level of repeaters is resident on a centerplane (not shown). The data interconnect 40 is capable of such complex functions as dividing the system into completely isolated partitions and dividing the system into logically isolated domains, allowing hot-plug and unplug of individual boards.

In the illustrated embodiment, each processing board 30(1-6) may include up to four processors 45. Each processor 45 has an associated e-cache 50, memory controller 55 and up to eight dual in-line memory modules (DIMMs) 60. Dual CPU data switches (DCDS) 65 are provided for interfacing the processors 45 with the data interconnect 40. Each pair of processors 45 (i.e., two pairs on each processing board 30(1-6)) share a DCDS 65. Also, in the illustrated embodiment, each I/O board 35(1-4) has two I/O controllers 70, each with one associated 66-MHz peripheral component interface (PCI) bus 75 and one 33-MHz PCI bus 80. The I/O boards 35(1-4) may manage I/O cards, such as peripheral component interface cards and optical cards, that are installed in the system 10.

In the illustrated embodiment, the processors 45 may be UltraSPARCIII™ processors also offered by Sun Microsystems, Inc. The processors are symmetric shared-memory multiprocessors implementing the UltraSPARC III protocol. Of course, other processor brands and operating systems 12 may be employed.

Selected modules in the system 10 are designated as field replaceable units (FRUs) and are equipped with FRU identification (FRUID) memories 95. Exemplary FRUs so equipped may include the system controller boards 15(1-2), the processing boards 30(1-6), and the I/O boards 35(1-4). The system 10 may also include other units, such as a power supply 85 (interconnections with other devices not shown), a cooling fan 90, and the like, equipped with FRUIDs 95, depending on the particular embodiment. The system 10 may be configured to allow hot or cold swapping of the field replaceable units. However, some field replaceable units may be required to be serviced and/or replaced at a repair depot.

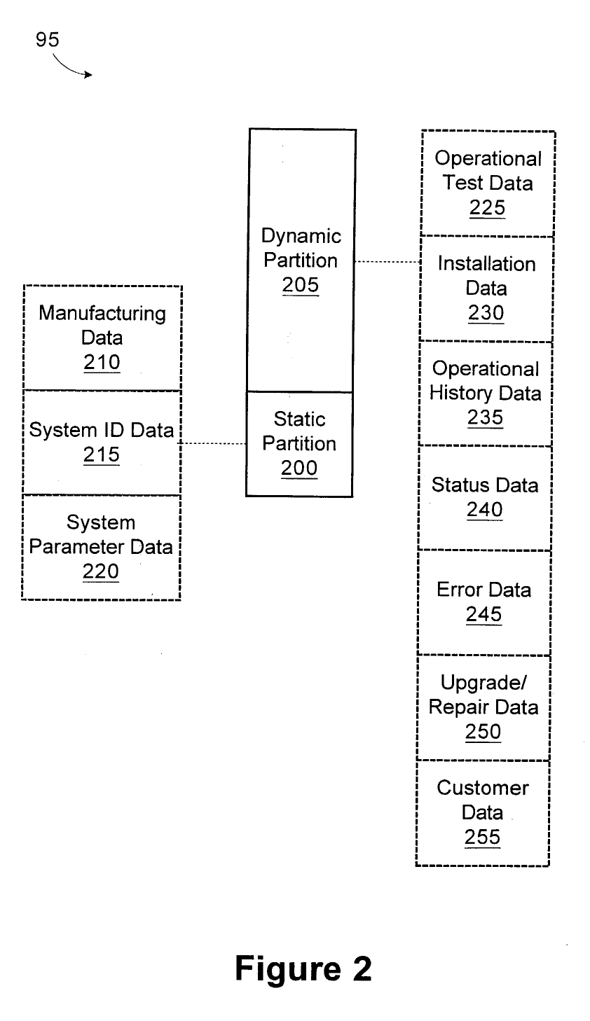

Turning now to FIG. 2, a simplified diagram of the FRUID 95 is provided. In the illustrated embodiment, the FRUID 95 is a serial electrically erasable programmable read-only memory (SEEPROM) and has an 8 Kbyte space to store information about the associated FRU. Of course, other memory types and storage sizes may be used depending on the particular implementation. The FRUID 95 includes a 2 Kbyte static partition 200 dedicated to store “static” information and a 6 Kbyte dynamic partition 205 to store “dynamic” information.

The static information includes:

Manufacturing Data 210;

System ID Data 215; and

System Parameter Data 220.

The dynamic information includes:

Operational Test Data 225;

Installation Data 230;

Operational History Data 235;

Status Data 240;

Error Data 245;

Upgrade Repair Data 250; and

Customer Data 255.

The particular format for storing data in the FRUID 95 is described in greater detail in U.S. Provisional Patent Application Serial No. 60/381,400, incorporated above.

Some of the benefits derived from the information stored in the FRUID 95 are:

Fatal Error Identification—a fatal error bit may be set on FRU failure and will remain set until after the FRU has been repaired and reset by the repair depot to prevent “accidental” reuse of the failed FRU;

Ease of Tracking Errors—in the event the FRU has been “repaired” and returned to the field, and failed again subsequently with the same or similar failure, the failure log is tagged to insure special attention will be given to the failed FRU;

Trend Analysis—quick identification of certain batch of FRUs with known defects can be done by a serial number embedded into the SEEPROM;

Trend Analysis—quick analysis can be performed by collecting information of specific FRUs, including power-on hours, temperature logs, and the like;

Trend Analysis—quick identification of components from specific vendors on premature failures of certain FRUs; and

Field Change Orders can be applied easily with patches after identifying the range of affected FRU by serial numbers.

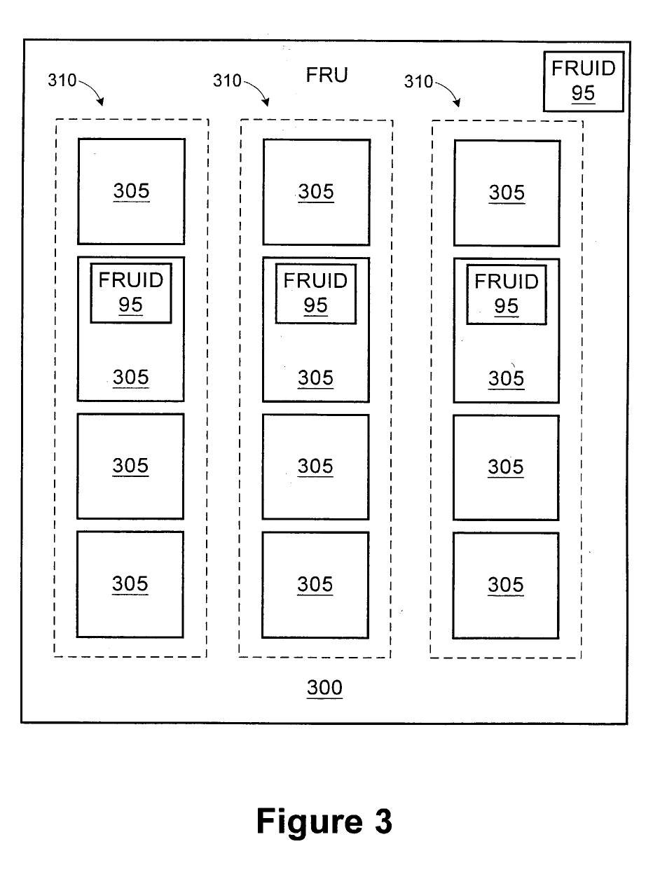

Referring now to FIG. 3, a simplified block diagram of an exemplary FRU 300 having a FRUID 95 is shown. As described above, the FRU 300 may represent one of the system control boards 15(1-2), one of the processing boards 30(1-6), one of the input/output (I/O) boards 35(1-4), the power supply 85, the cooling fan 90, and the like. The FRU 300 includes a plurality of submodules 305. For example, the FRU 300 may be a processing board 30(1-6), and the submodules 305 may be the processors 45, e-caches 50, memory controllers 55, and DIMMs 60. Selected submodules 305 (e.g., the DIMMS 60) may also be themselves field replaceable and have their own FRUIDs 95. The submodules 305 may be organized into groups 310. For example, a processor 45 and its associated e-cache 50, memory controller 55, and DIMMS 60 may be organized into a single group 310.

Information may be stored in the FRUID 95 by the system controller 20, the operating system software 12, or another software application executed by the system 10. Alternatively, information may be stored in the FRUID 95 by a different computer system or interface (not shown) when the FRU 300 is removed for repair, maintenance, or upgrade

Returning to FIG. 2, the data stored in the static partition 200 and dynamic partition 205 is now described in greater detail. The particular types of static and dynamic data stored in the FRUID 95 that are detailed herein are intended to be exemplary and non-exhaustive. Additional static and dynamic data may be stored in the FRUID 95, depending on the particular implementation. The information stored in the static partition 200 is typically information that is not expected to change over the service life of the FRU 300, while the dynamic data includes data that is written to the FRUID 95 during its service life. The dynamic data may be written by the manufacturer, a repair depot, or by the system itself during operation of the FRU 300 at a customer installation.

The manufacturing data 210 may include information such as the part number, serial number, date of manufacture, and vendor name. The system ID data 215 may include information such as an ethernet address and a system serial number (i.e., of the system in which the FRU is installed). The system parameter data 220 may include information about the system, such as maximum speed, DIMM speed, maximum power, and the like.

The operational test data 225 provides information about the most recent iteration of tests performed on the FRU 300. The operational test data 225 is typically written during the manufacture of the FRU 300 or while it is being repaired, not while the FRU 300 is in the field. When the FRU 300 is received at a repair depot, the operational test data 225 may be accessed to determine which tests had been previously run on the FRU 300. For each of the possible tests that may be run on the FRU 300, a summary record may be provided that indicates when the test was performed and the revision of the testing procedure used.

The installation data 230 specifies where the FRU 300 has been used, including the system identity and details of the parent FRU (i.e., the FRU in which the current FRU 300 is installed). The installation data 230 may also include geographical data (e.g., latitude, longitude, altitude, country, city or postal address) related to the installation.

The operational history data 235 includes data related to selected parameters monitored during the service life of the FRU 300. For example, the operational history data 235 may include power events and/or temperature data.

Power on and off events are useful in reconstructing the usage of the FRU 300. The power event data could indicate whether the FRU 300 was placed in stock or installed in a system and shipped. The idle time would indicate the shelf life at a stocking facility before use. The time interval between a fatal error and a power on at a repair center could be used to track transit time. The total on time could be used to generate a mean time before failure metric or a mean time before fatal error metric.

Temperature data is useful for analyzing service life and failure rates. Failure rate is often directly dependent on temperature. Various aging mechanisms in the FRU 300 run at temperature controlled rates. Cooling systems are generally designed based on predicted failure rates to provide sufficient cooling to keep actual failure rates at an acceptable level. The temperature history may be used for failed components to determine whether predicted failure rates are accurate. Temperature history can affect failure rate both by aging and by failure mechanisms unrelated to aging. Minimum and maximum operating temperatures are recorded to establish statistical limits for the operating range of the FRU 300. Temperature values are grouped into bins, with each bin having a predetermined range of temperatures. The count of time in each temperature bin defines the temperature history of the operating environment. A last temperature record may be used to approximate the temperature of the FRU 300 when it failed. Temperature data from one FRU 300 may be compared to the histories of other like FRUs to establish behavior patterns. Failure histories may be used to proactively replace temperature-sensitive parts.

The status data 240 records the operational status of the FRU 300 as a whole, including whether it should be configured as part of the system or whether maintenance is required. If maintenance is required, a visible indication may be provided to a user by the system. Exemplary status indications include out-of-service (OOS), maintenance action required (MAR), OK, disabled, faulty, or retired. A human-supplied status bit may be used to indicate that the most recent status was set by human intervention, as opposed to automatically by the system. A partial bit may also be used to indicate while the entire FRU 300 is not OOS, some components on the FRU 300 may be out-of-service or disabled. If the system sees the partial bit checked, it checks individual component status bits to determine which components are OOS or disabled. The status data 240 may also include a failing or predicted failing bit indicating a need for maintenance.

The error data 245 includes soft errors from which the system was able to recover. These soft errors include error checking and correction (ECC) errors that may or may not be correctable. The type of error (e.g., single bit or multiple bits) may also be recorded. A rate-limit algorithm may be used to change the status of the FRU 300 to faulty if more than N errors occur within a FRU-specific time interval, T.

The upgrade/repair data 250 includes the upgrade and repair history of the FRU 300. The repair records include repair detail records, a repair summary record, and an engineering change order (ECO) record. Typically, the repair records are updated at a repair depot when a repair is completed on the FRU 300. The repair information stored on the FRUID 95 may also include the number of times a returned FRU 300 is not diagnosed with a problem. During a repair operation, one or more engineering change orders (ECOs) may be performed on the FRU 300 to upgrade its capability (e.g., upgrade a processor 45) or to fix problems or potential problems identified with the particular FRU 300 model. For example, a firmware change may be implemented or a semiconductor chip (e.g., application specific integrated circuit (ASIC)) may be replaced.

The customer data 255 is generally a free-form field in which the customer may choose to store any type of desired information, such as an asset tag, the customer's name, etc. The customer data 255 may be updated at the customer's discretion.

Data stored in the FRUID 95 may be used by the system controller 20 for configuring the system 10, and/or identifying the presence of unqualified components. The term “unqualified components” includes those components that are not approved for use in the system 10 and also those counterfeit components that are configured to appear as if they are qualified components.

During a configuration event, the system controller 20 queries the FRUIDs 95 of the components in the system 10 to identify their capabilities. Based on data stored in the FRUID 95, the system controller 20 may authenticate the FRU 300 for use in the system 10. Configuration events may occur upon the initial startup of the system 10, or alternatively, during an automatic system configuration that occurs during operation of the system 10 (e.g., following the replacement of a failed component the system 10 may be reconfigured without requiring a total reset). Various techniques may be used to authenticate the FRU 300 and exemplary techniques are described in greater detail below. After failing to authenticate a FRU 300, the system controller 20 may disable the unqualified FRU 300 to prevent its use from compromising the system 10. The system controller 20 may also send an alert message to notify an operator/administrator of the system 10 of the authentication failure so that corrective action may be taken. An alert message may also be provided to a manufacturer, vendor, or maintenance provider for the system 10 to indicate the authentication failure, so that appropriate service personnel may be dispatched. In one embodiment, the unqualified FRU 300 may be disabled immediately. In another embodiment, the operator/administrator may be given a grace period in which to act to replace the unqualified FRU 300 prior to its being disabled.

For purposes of illustration, the authentication of a DIMM 60 (see FIG. 1) will be described, however, the invention is not so limited and may be applied to other types of FRUs 300.

One authentication technique involves verifying the qualification status of the particular FRU 300 and the vendor that supplied the FRU 300 with respect to its acceptability in the system 10. The system controller 20 may access the manufacturing data 210 to identify the particular part number and vendor of each FRU 300. Such manufacturing data 210 may be referred to as identification data. Of course additional parameters or entirely different parameters may be used in the qualification status review, depending on the particular implementation. The system controller 20 may then compare the identification data extracted from the FRUID 95 to data stored in a qualification table 100 (see FIG. 1) maintained for the system 10. The qualification table 100 includes data for qualified parts and vendors. For security purposes, the qualification table 100 may be encrypted and stored on the system 10 (e.g., by the manufacturer) and may be updated periodically during service events or dynamically by the system controller 20 or a software application (not shown) over an external network connection (e.g., the Internet). If the system controller 20 identifies that the particular FRU 300 is not qualified based on the information in the qualification table 100, the FRU 300 may be marked as unqualified. A counterfeit part may also be identified by the system controller 20 in comparing the manufacturing data 210 across the various FRUs 300 in the system 10. If a counterfeiter attempted to duplicate a FRUID image bit-for-bit and store redundant FRUID images in multiple FRUs 300, the serial numbers for the FRUs 300 would not be unique. Checking of the identification data against the qualification table 100 and/or checking for duplicate serial numbers may be referred to as identity authentication checking.

The system controller 20 may also perform other authentication checks in lieu of or in addition to the identification test described above. For example, data in the FRUID 95 may be protected with security codes and/or checksums. If the security code or checksum is incorrect, it may indicate a failed FRUID 95. Alternatively, a failure could be indicative of a counterfeit part. A manufacturer of a counterfeit FRU 300 may attempt to use the data extracted from a qualified FRU 300 to generate a FRUID image that would appear to represent a qualified FRU 300. If the counterfeiter did not know the particular algorithms used to generate the security codes or checksums, these codes would be incorrect. Security code, checksum, or serial number authentication failures may be used by the system controller 20 to flag the FRUs 300 as unqualified. If a FRU 300 without an associated FRUID 95 were to be installed in the system 10, the system controller 20 would not be able to perform any authentication activities, and the FRU 300 would be listed as unqualified. In cases where the authentication failure occurs due to a faulty FRUID 95, as opposed to the presence of an actual unqualified part, the system controller 20 still disables the FRU 300 and lists it as unqualified. Subsequent troubleshooting activities may be conducted to determine the actual cause of the authentication failure, and a FRU 300 that was determined to have a faulty FRUID 95 could be repaired. Authentication activities such as checking the security codes, checksums, and/or FRUID 95 presence may be referred to as integrity authentication checks.

Based on the information gathered during the configuration cycle from the identification and integrity authentication checks, the system controller 20 constructs a component map 105 of the system 10. The component map 105 details the submodules 305 associated with the associated FRUs 300 and includes enable bits for selected FRUs 300 and submodules 305 to allow enabling and/or disabling of the FRUs 300 or submodules 305 for various purposes, including the qualification purposes described herein. The component map 105 may be accessed by the system controller 20 to assert or de-assert the enable bits for a particular FRUs 300 or submodules 305 based on the authentication checks performed.

In the illustrated embodiment, the component map 105 may be employed to disable unqualified components in the system 10 and allow for continued operation of the reminder of the system 10. When the system controller 20 identifies an unqualified component it accesses the component map 105 to disable the defective component. The disabling of different components may be implemented on different levels. For example, an entire FRU 300 may be disabled (e.g., processor board 30(1-6)), a group 310 of submodules 305 may be disabled (e.g., processor 45 and its associated e-cache 50, memory controller 55, and DIMMS 60), or a single submodule 305 may be disabled (e.g., DIMM 60), depending on the particular condition.

In another embodiment, the FRU 300 or submodule 305 may be disabled by setting various status bits in the status data 240 stored in the FRUID 95 (see FIG. 2). In the status data 240, the partial bit may be used to disable one or more of the submodules 305 without disabling the entire FRU 300.

In an example where a DIMM 60 is identified as being unqualified, the DIMM 60 and any other DIMMs 60 in a common bank are disabled. If only one bank is assigned to a particular processor 45, the processor 45 and its associated e-cache 50, and memory controller 55 are also disabled.

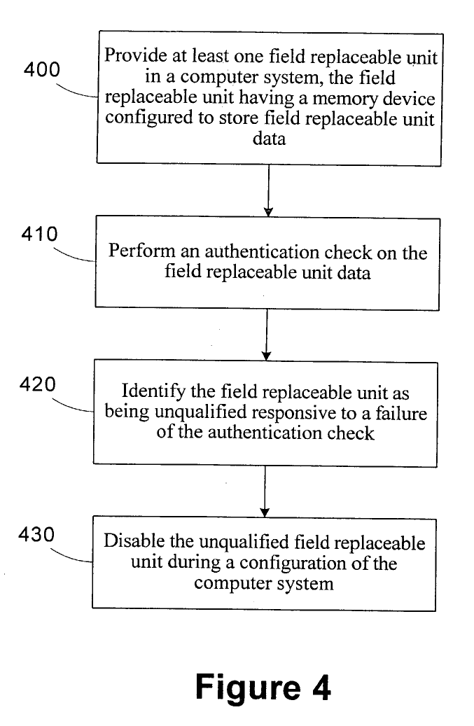

Turning now to FIG. 4, a simplified flow diagram of a method for configuring a computer system, such as the system 10 of FIG. 1, in accordance with another embodiment of the present invention is provided. In block 400, at least one field replaceable unit 300 is provided in a computer system 10. The field replaceable unit 300 has a memory device 95 configured to store field replaceable unit data. In block 410, an authentication check is performed on the field replaceable unit data. In one embodiment, the authentication check may be an identity authentication check based on identification data stored in the memory to device 95. For example, the identification data may be compared to a qualification table 100 of components qualified for use in the computer system 10. In another embodiment, the authentication check may be an integrity authentication check of the field replaceable data. In block 420, the field replaceable unit 300 is identified as being unqualified responsive to a failure of the authentication check. In block 430, the unqualified field replaceable unit 300 is disabled during a configuration of the computer system 10. The unqualified field replaceable unit 300 may be disabled by accessing a component map 105 of the computer system 10. Alternatively, the unqualified field replaceable unit 300 may be disabled by setting status data stored in the memory device 95 to a disabled state.

Authentication of the FRUs 300 in the system 10, as described herein, allows identification of unqualified components. Disabling unqualified components protects the integrity of the system 10 by preventing the unqualified part from potentially degrading the system performance or from causing faults in the system 10 that result in downtime or the need for repair.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method, comprising:
providing at least one field replaceable unit in a computer system, the field replaceable unit having a memory device configured to store field replaceable unit data;
performing an authentication check on the field replaceable unit data, wherein the field replaceable unit data includes identification data and wherein performing the authentication check comprises evaluating the identification data to determine a qualification status of the field replaceable unit; and
identifying the field replaceable unit as being unqualified responsive to a failure of the authentication check.

2. The method of claim 1, further comprising disabling the unqualified field replaceable unit during a configuration of the computer system.

3. The method of claim 2, wherein disabling the unqualified field replaceable unit further comprises:
generating a component map for the computer system, the component map including enable information; and
accessing the component map to disable the unqualified field replaceable unit.

4. The method of claim 2, wherein the field replaceable unit data includes status data and disabling the unqualified field replaceable unit further comprises setting the status data in the memory device of the unqualified field replaceable unit to a disabled state.

5. The method of claim 2, further comprising disabling at least one other component in the computer system associated with the unqualified field replaceable unit.

6. The method of claim 5, wherein the field replaceable unit comprises a memory module, the at least one other component comprises a processor, and disabling the at least one other component further comprises disabling the processor responsive to the memory module being identified as unqualified.

7. The method of claim 2, wherein the field replaceable unit comprises a first memory module configured in a bank arrangement with at least a second memory module, and the method further comprises disabling the second memory module responsive to the first memory module being identified as unqualified.

8. The method of claim 2, wherein disabling the unqualified field replaceable unit further comprises disabling the unqualified field replaceable unit after a grace period.

9. The method of claim 1, wherein performing the authentication check further comprises:
providing a qualification table of components qualified for use in the computer system; and
comparing the identification data to the qualification table.

10. The method of claim 1, wherein the field replaceable unit data includes an integrity code and performing the authentication check further comprises verifying the accuracy of the integrity code based on the field replaceable unit data.

11. The method of claim 1, further comprising sending an alert message responsive to identifying the unqualified field replaceable unit.

12. A method, comprising:
providing a plurality of field replaceable units in a computer system, each field replaceable unit having a memory device configured to store field replaceable unit data associated with its field replaceable unit;
performing an authentication check on the field replaceable unit data for each of the field replaceable units, wherein the field replaceable unit data includes identification data and performing the authentication check comprises comparing the identification data across the field replaceable units; and
identifying members of the plurality of field replaceable unit as being unqualified responsive to a failure of the authentication check.

13. The method of claim 12, further comprising disabling any unqualified field replaceable units during a configuration of the computer system.

14. The method of claim 13, wherein disabling the unqualified field replaceable unit further comprises:
generating a component map of the field replaceable units in the computer system, the component map including enable information; and
accessing the component map to disable any unqualified field replaceable units.

15. The method of claim 13, wherein the field replaceable unit data includes status data and disabling any unqualified field replaceable units further comprises setting the status data in the memory device of any unqualified field replaceable units to a disabled state.

16. The method of claim 13, wherein at least two of the field replaceable units are associated with one another and the method further comprises disabling the other of the associated field replaceable units responsive to one of the associated field replaceable units being identified as unqualified.

17. The method of claim 16, wherein the associated field replaceable units comprise first and second memory modules configured in a bank arrangement, and the method further comprises disabling the second memory module responsive to the first memory module being identified as unqualified.

18. The method of claim 16, wherein the associated field replaceable units comprise a memory module and a processor, and the method further comprises disabling the processor responsive to the memory module being identified as unqualified.

19. The method of claim 13, wherein disabling the unqualified field replaceable unit further comprises disabling the unqualified field replaceable unit after a grace period.

20. The method of claim 12, wherein the identification data includes a serial number for the field replaceable unit, and comparing the identification data further comprises comparing serial numbers of the field replaceable units to identify duplicate serial numbers.

21. The method of claim 20, further comprising identifying field replaceable units with duplicate serial numbers as being unqualified.

22. The method of claim 12, wherein the field replaceable unit data includes identification data and performing the authentication check further comprises:
providing a qualification table of components qualified for use in the computer system; and
comparing the identification data to the qualification table.

23. The method of claim 12, wherein the field replaceable unit data includes an integrity code and performing the authentication check further comprises verifying the accuracy of the integrity code based on the field replaceable unit data stored in the associated memory device.

24. The method of claim 12, further comprising sending an alert message responsive to identifying the unqualified field replaceable unit.

25. A computer system, comprising:
at least one field replaceable unit, the field replaceable unit having a memory device configured to store field replaceable unit data; and
a system controller configured to perform an authentication check on the field replaceable unit data, and identify the field replaceable unit as being unqualified responsive to a failure of the authentication check;
wherein the field replaceable unit data includes identification data and the system controller is further configured to evaluate the identification data to determine a qualification status of the field replaceable unit.

26. The system of claim 25, wherein the system controller is further configured to disable the unqualified field replaceable unit during a configuration of the computer system.

27. The system of claim 26, wherein the system controller is further configured to generate a component map for the computer system, the component map including enable information, and access the component map to disable the unqualified field replaceable unit.

28. The system of claim 26, wherein the field replaceable unit data includes status data and the system controller is further configured to set the status data in the memory device of the unqualified field replaceable unit to a disabled state.

29. The system of claim 26, wherein the system controller is further configured to disable at least one other component in the computer system associated with the unqualified field replaceable unit.

30. The system of claim 29, wherein the field replaceable unit comprises a memory module, the at least one other component comprises a processor, and the system controller is further configured to disable the processor responsive to the memory module being identified as unqualified.

31. The system of claim 26, wherein the field replaceable unit comprises a first memory module configured in a bank arrangement with at least a second memory module, and the system controller is further configured to disable the second memory module responsive to the first memory module being identified as unqualified.

32. The system of claim 26, wherein the system controller is further configured to disable the unqualified field replaceable unit after a grace period.

33. The system of claim 25, wherein the system controller is further configured to access a qualification table of components qualified for use in the computer system and compare the identification data to the qualification table to determine the qualification status.

34. The system of claim 25, wherein the field replaceable unit data includes an integrity code and the system controller is further configured to verify the accuracy of the integrity code based on the field replaceable unit data.

35. The system of claim 25, wherein the system controller is further configured to send an alert message responsive to identifying the unqualified field replaceable unit.

36. A computer system, comprising:
a plurality of field replaceable units in a computer system, each field replaceable unit having a memory device configured to store field replaceable unit data associated with its field replaceable unit;
a system controller configured to perform an authentication check on the field replaceable unit data for each of the field replaceable units, and identify members of the plurality of field replaceable unit as being unqualified responsive to a failure of the authentication check;
wherein the field replaceable unit data includes identification data and the system controller is further configured to compare the identification data across the field replaceable units.

37. The system of claim 36, wherein the system controller is further configured to disable any unqualified field replaceable units during a configuration of the computer system.

38. The system of claim 37, wherein the system controller is further configured to generate a component map of the field replaceable units in the computer system, the component map including enable information, and access the component map to disable any unqualified field replaceable units.

39. The system of claim 37, wherein the field replaceable unit data includes status data and the system controller is further configured to set the status data in the memory device of any unqualified field replaceable units to a disabled state.

40. The system of claim 37, wherein at least two of the field replaceable units are associated with one another and the system controller is further configured to disable the other of the associated field replaceable units responsive to one of the associated field replaceable units being identified as unqualified.

41. The system of claim 40, wherein the associated field replaceable units comprise first and second memory modules configured in a bank arrangement.

42. The system of claim 40, wherein the associated field replaceable units comprise a memory module and a processor.

43. The system of claim 36, wherein the identification data includes a serial number for the field replaceable unit, and the system controller is further configured to compare serial numbers of the field replaceable units to identify duplicate serial numbers.

44. The system of claim 43, the system controller is further configured to identify field replaceable units with duplicate serial numbers as being unqualified.

45. The system of claim 36, wherein the field replaceable unit data includes identification data and the system controller is further configured to access a qualification table of components qualified for use in the computer system and compare the identification data to the qualification table.

46. The system of claim 36, wherein the field replaceable unit data includes an integrity code and the system controller is further configured to verify the accuracy of the integrity code based on the field replaceable unit data stored in the associated memory device.

47. A system, comprising:
at least one field replaceable unit having a memory device configured to store field replaceable unit data;
means for performing an authentication check on the field replaceable unit data; and
means for identifying the field replaceable unit as being unqualified responsive to a failure of the authentication check;
wherein the field replaceable unit data includes identification data and the means for performing an authentication check includes a means for evaluating the identification data to determine a qualification status of the field replaceable unit.

48. A system, comprising:
a plurality of field replaceable units each having a memory device configured to store field replaceable unit data associated with its field replaceable unit;
means for performing an authentication check on the field replaceable unit data for each of the field replaceable units; and
means for identifying members of the plurality of field replaceable unit as being unqualified responsive to a failure of the authentication check;
wherein the field replaceable unit data includes identification data and the means for performing an authentication check includes a means for comparing the identification data across the field replaceable units.
